(19) United States
(12) Patent Application Publication
(10) Pub. No.: US 2019/0047824 A1
(43) Pub. Date: Feb. 14, 2019

(54) WIND TURBINE DESCENT SYSTEM

(71) Applicant: Vestas Wind Systems A/S, 2Aarhus N. (DK)

(72) Inventors: Esben Eskerod Ifversen, Skødstrup (DK); Claus Hald Therkildsen, Ryomgård (DK)

(21) Appl. No.: 16/079,284

(22) PCT Filed: Mar. 14, 2017
(86) PCT No.: PCT/DK2017/050071

§ 371 Date: Aug. 23, 2018

(30) Foreign Application Priority Data
Mar. 22, 2016 (DK) PA 2016 70166

(51) Int. Cl. B66B 9/00; A62B 1/02; F03D 80/50; B66B 7/04; B66B 11/00; B66B 11/04; B66B 11/02

(52) U.S. Cl. CPC B66B 9/00; A62B 1/02; F03D 80/50; B66B 7/046; F05B 2220/30; B66B 11/04; B66B 11/0226; F05B 2240/916; B66B 11/0035

(57) ABSTRACT

The present invention provides a wind turbine comprising a tower, a nacelle, and a descent module configured to accommodate at least one person while descending down at least a portion of a height of the tower, wherein the descent module is arranged to be magnetically attracted to the tower to guide the descent module relative to the tower over at least a portion of the descent. The present invention also provides a descent module for a wind turbine, and a method of lowering at least one person down at least a portion of a height of a tower of a wind turbine.

### FIELD OF THE INVENTION

The present invention relates to a wind turbine, to a descent module for a wind turbine, and to a method of lowering at least one person down at least a portion of a height of a tower of a wind turbine in case of an emergency.

### BACKGROUND

A typical wind turbine comprises a tower that supports a rotatable nacelle at the upper end thereof. The nacelle is provided with a rotor including at least one blade, an electrical generator, and a drivetrain coupling the rotor to the electrical generator.

Access to the inside of the tower and/or the nacelle for one or more people (such as engineers or mechanics) may be required at various different times, for example during assembly, inspection and maintenance operations. For this purpose an internal lift system such as an elevator may be provided in the tower. The lift system may extend from an entry point near the base of the tower into the nacelle to allow direct access to the nacelle.

Alternatively the lift system may end in a top portion of the tower from which the nacelle may be accessed via an external access apparatus. For example, WO2012/122989A1 describes an access apparatus comprising a passageway leading to the interior of the nacelle that may be entered from a door provided in the top portion of the tower.

Within the field of wind turbines, unfortunately accidents involving e.g. fire or the like have shown to take place at rare occasions. As the number of wind turbines in operation is increasing, it may be expected that these accident numbers will increase in the future. Factors such as an increasing (average) age of many operating wind turbines might be expected to influence the accident numbers, but also fire accidents etc. involving new and relatively new wind turbines are increasing in numbers. In wind turbines there have been implemented various measures to reduce e.g. fire risk, for example by including fire extinguishing systems, but in spite of this fire incidents and accidents occur at an increasing rate in wind turbines. Such accidents naturally lead to damages to components in the wind turbine and even to essentially total damages to e.g. the nacelle, the rotor blades, etc., within a relatively short time after a fire has started, e.g. due to the inflammable materials present in the nacelle, including inflammable liquids such as hydraulic liquids, oil products, etc., due to the electric and electronic equipment and components in general, and due to the materials in the rotor blades, which damages in itself are unfortunate.

But even more disastrous is it, if persons are involved in such accidents, e.g. in particular in case one or more person is/are present in the wind turbine, for example being in the process of servicing the wind turbine components in/on the nacelle, the rotor blade components, components in the top of the wind turbine tower, or the like. In such cases it may be difficult for the person or persons to escape from e.g. the nacelle, since the natural and usual way down, e.g. through a floor hatch in the nacelle down to the tower, may be impossible to use because of e.g. fire, smoke, heat, etc. and in any case such an escape route may be too troublesome to use and may not provide a sufficiently speedy escape.

In this connection it is noted that normally at least two service persons will be present in the wind turbine during service work, etc. (e.g. due to safety rules, etc.) and that in several situations as many as 4-10 persons or even more may be present at the same time in the wind turbine, particularly in the larger wind turbines, during service, repair, etc. since it is of importance to minimize the standstill of the wind turbine. In case of an emergency it is of importance that all persons present in the wind turbine can be evacuated effectively and quickly. This is accentuated by the fact that fire accidents in wind turbines have shown to sometimes evolve very quickly, e.g. within a relatively short timeframe of a few minutes. Thus, it is very important to be able to escape quickly. This is, however, in many instances prohibited due to the high levels involved and the remote locations of the wind turbines, in particular at sea. This also makes fire extinguishing using traditional fire trucks or the like impossible and naturally also makes it in practice impossible to rescue persons using such traditional fire truck material.

In recent years a number of wind turbine accidents, in particular fire accidents, have occurred, where persons have been injured or even lost their life because they have not been able to escape from an upper level of a wind turbine, e.g. from the nacelle or the top of the wind turbine tower. Therefore, it may, on rare occasions, be necessary to evacuate one or more people from the top of the wind turbine in an emergency. In such evacuation situations it may be impossible (or at least undesirable) to use the internal lift system to descend from the top of the wind turbine. It could for example be in case of a fire inside the tower or in the area of access between the nacelle and the tower. In this case, a person may abseil or be lowered down from the top of the wind turbine on a cable. For example, WO2012/122989A1 describes an emergency evacuation system in which a person may exit the access apparatus via a closure member and then be lowered down from the top of the wind turbine in a stretcher-like carriage on a cable.

However, known evacuation systems for descending from the top of a wind turbine without using the internal lift system generally require people to be lowered individually. In addition, known evacuation systems may take time to set up, may require specialist skills to operate, and may be difficult to operate in strong winds.

GB2476329A describes a system for ascending or descending from a tower structure such as a wind turbine that does not require use of an internal lift system. The ascending/descending system of GB2476329A comprises a capsule that may be detachably coupled to a chassis that is mounted on a rail assembly provided on the outside of the tower structure. However, the ascending/descending system of GB2476329A requires extensive modifications to the tower structure, is complicated and expensive, and may be difficult to operate in an emergency situation.

It is an object of the present invention to provide a system for descending from a wind turbine that addresses the shortcomings of the prior art.

### SUMMARY OF THE INVENTION

It has been realized by the inventor that there is a need for providing an emergency escape possibility for persons who are situated at upper levels at a wind turbine, for example persons performing various work in or on the nacelle, at the hub, at the top of the wind turbine tower, etc.

Thus, it is an objective of the invention to provide improved escape possibilities for persons at the upper level of a wind turbine.

Thus, it is also an objective to avoid accidents involving people and to provide measures to avoid fatal accidents occurring in connection with persons working in wind turbines, when for example fire incidents occur and in general to improve the safety.

It is also an objective to provide an emergency escape possibility, which ensures that the persons are evacuated in a safe and controlled manner and whereby they after being evacuated are protected from further adverse conditions.

Further, it is an objective to provide an emergency escape possibility, whereby an escape can be performed quickly, e.g. in view of the time frame that may be available after a fire has started and until it has reached a dangerous level.

Further, it is an objective to provide such an emergency escape possibility, whereby it is also possible to evacuate a person or persons that has/have been injured, e.g. persons having sustained head injury, spine injury, burn injury, heart attack, etc.. These and other objectives are achieved by the invention as explained in detail in the following.

A first aspect of the invention provides a wind turbine comprising a tower, a nacelle, and a descent module configured to accommodate at least one person while descending down at least a portion of a height of the tower, wherein the descent module is arranged to be magnetically attracted to the tower to guide the descent module relative to the tower over at least a portion of the descent.

As opposed to known evacuation systems which may take time to set up, may require specialist skills to operate, and may be difficult to operate in strong winds, the present solution is quick, reliable and straight-forward to use. Everyone will be able to trigger a descent without having to search for and preparing climbing equipment or similar. Furthermore, the descent module is ensuring that the number of people in the turbine can get down in one go as opposed to previous safety equipment, which typically can only take one or maximum two people at a time.

The wind turbine may be either an on-shore wind turbine or an off-shore wind turbine.

By magnetically attracting the descent module to the tower over at least a portion of the descent, the invention allows the descent module to be safely and reliably guided relative to the tower of the wind turbine during its descent.

It will be appreciated that the magnetic attraction between the descent module and the tower is sufficiently strong to ensure safe and reliable guiding of the descent module. The required force may vary depending on the specific application, for example depending on the height of the tower, the local wind conditions, the size of the descent module, and the desired or maximum speed for the descent. It is within the capabilities of the skilled person to design an appropriate magnetic attraction.

The descent module may be arranged to descend from an initial position at or near to a top of the tower to a location at or near to a base of the tower, for example to ground level or to an access platform. Typically, in a normal condition the descent module is releasably located at a position at the nacelle (3) of the wind turbine to be ready for an emergency situation.

The descent module may be arranged to be magnetically attracted to the tower over at least a substantial portion of the descent and/or the overall height of the tower, and in some cases over substantially the entire descent and/or the overall height of the tower. In some cases magnetic guiding may not be required over a lower portion of the descent, although the descent module is preferably arranged to be magnetically attracted to the tower over at least an upper portion of the descent, for example over at least the first 25% or first 50% of the descent.

The magnetic attraction between the descent module and the tower may be generated by at least one permanent magnet and/or at least one electromagnet. The descent module may be magnetically attracted to the tower using at least one magnet comprised in the descent module and/or at least one magnet comprised in the tower, as described in more detail below.

The descent module may comprise a plurality of tower engaging elements arranged to engage (for example rest against) at least a portion of the tower over at least a portion of the descent.

The tower engaging elements may be arranged to engage an outer surface of the main body of the tower. In this case the tower engaging elements may run directly along the main body of the tower, and so it may not be necessary to provide any additional mechanical components in or on the tower for the purposes of engaging the descent module. Alternatively, the tower engaging elements may be arranged to engage a separate track (for example a rail or pad) that is provided in or on the tower specifically for the purpose of engaging the descent module.

The tower engaging elements may be arranged to pivot in use in order to follow the shape of the tower over the descent. For example, one or more tower engaging elements may be arranged to pivot in order to maintain contact (and preferably substantially normal contact) with the outer surface of the tower during a descent where the outer surface of the tower varies in diameter and/or shape along the height of the tower. The tower engaging elements may be arranged to pivot about pivot axes that are substantially vertical and substantially parallel to an outer surface of the tower during the descent. Where the tower engaging elements are arranged in a plurality of sets, the tower engaging elements comprised in each set may be arranged to pivot together.

The tower engaging elements may be wheels that are arranged to engage and roll along at least a portion of the tower (and optionally an outer surface of the main body of the tower) over at least a portion of the descent. The wheels may be arranged in a plurality of sets each comprising two or more wheels. The descent module may, for example, comprise four wheels (or four sets of wheels) in a substantially square or rectangular arrangement. Other numbers and configurations of wheels (or sets of wheels) are also possible. Alternatively, or in addition, the descent module may comprise one or more other tower engaging elements, such as bearing surfaces like skids or rails that are arranged to slide along at least a portion of the tower over at least a portion of the descent.

The descent module may comprise at least one magnet arranged to attract at least one magnetic component of the tower to thereby guide the descent module relative to the tower over at least a portion of the descent. The at least one magnetic component of the tower is not required to be a magnet (such as a permanent magnet or an electromagnet) itself, but instead is only required to be attractable by the at least one magnet of the descent module. For example, the at least one magnetic component of the tower may be formed of or comprise a magnetic material (optionally a ferromagnetic material) such as steel.

The at least one magnetic component of the tower may comprise at least one structural component of the tower. In this case the at least one magnet comprised in the descent module may be arranged to attract one or more structural components of the tower itself, and so it may not be necessary to provide any additional magnetic components in the tower for the purposes of magnetically guiding the descent module. The at least one magnetic structural component of the tower may comprise, for example, at least one panel, tower section or reinforcing strut of the tower that is formed of steel or another magnetic material. Alternatively, or in addition, the at least one magnetic component of the tower may comprise a separate magnetic track (a track that is attractable by a magnet) that is provided specifically for the purpose of guiding the descent module relative to the tower. Such a track may, for example, be attached to the inside or outside of the tower.

The magnet(s) may be provided at one or more intermediate locations between the plurality of tower engaging elements of the descent module.

The magnet(s) may be provided at one or more locations adjacent to one or more of the tower engaging element(s) of the descent module.

The magnet(s) may be comprised in one or more of the tower engaging elements of the descent module.

The magnet(s) are preferably arranged to be as close to the tower as is practical during the descent in order to maximise their effect.

As an alternative to the descent module comprising at least one magnet arranged to attract at least one magnetic component of the tower, the tower may instead comprise at least one magnet arranged to attract at least one magnetic component of the descent module to thereby guide the descent module relative to the tower over at least a portion of the descent. In this case the tower may comprise a track of magnets extending along at least a portion of its height. The at least one magnetic component of the descent module may comprise at least one magnetic tower engaging element (such as a tower engaging wheel), at least one magnetic structural component of the descent module, or at least one separate magnetic member that is provided in the descent module specifically for the purpose of guiding the descent module relative to the tower.

The wind turbine may further comprise an external access system located towards a top of the tower, and at least partially outside the nacelle and the tower, from which at least one person may enter the descent module. The external access system may comprise a cage providing a walkway that is located at least partially outside the nacelle and the tower, and may be at least substantially enclosed. The external access system may extend circumferentially around at least a portion of the tower.

The descent module may be located at least partially within the external access system when in its initial position before the start of a descent. Alternatively, the descent module may be located to the side of or below the external access system when in its initial position.

The descent module may be releasably mounted to the external access system and/or to the tower when in its initial position before the start of a descent.

The external access system may be attached to the tower. The external access system may be arranged to remain fixed relative to the tower as the nacelle rotates in use. Alternatively, the external access system may be attached to the nacelle.

The external access system may be arranged to be entered from the nacelle, for example through a door provided in a floor of the nacelle. Alternatively, or in addition, the external access system may be arranged to be entered from the tower, for example through a door provided in the tower.

The descent module may be arranged to be accessed directly from the nacelle or directly from the tower. In this case, when in its initial position, the descent module may be located at least partially within the nacelle or the tower, or alternatively to the side of or below the nacelle or the tower, and may be releasably mounted to the nacelle or the tower.

The wind turbine may further comprise a lowering mechanism for controlling the speed of descent of the descent module. The lowering mechanism may be mounted to the tower or to the nacelle or to the external access system (if present), and may comprise a cable that is attached to (or arranged to be attached to) the descent module. Alternatively, the lowering mechanism may be mounted to the descent module, and may comprise a cable that is attached to (or arranged to be attached to) the tower or the nacelle or the external access system (if present). The lowering mechanism may, for example, comprise a winch drum.

The lowering mechanism may additionally be operable to lift the descent module up the tower. Hereby, following an emergency, the descent module may right away be returned to the top of the tower.

The descent module is preferably arranged to accommodate a plurality of people to support group evacuation in a protected environment, and may optionally be arranged to accommodate at least one person on a stretcher. For example, the descent module may be arranged to accommodate at least two, at least three or at least four people.

In an embodiment of the invention, said descent module comprises manual input means, e.g. a handle, a knob or the like, which is designed for activating releasing means for providing a release from said position at said upper level. In case of emergency it should be very easy to activate a rapid descend from the top of the tower.

In an embodiment of the invention, said descent module is an essentially closed structure having an entrance, e.g. a door, a hatch or the like, for at least one person. As opposed to service situations where an open work platform is desired, in case of emergency it may be highly preferred that people can descend without e.g. being exposed to falling objects from a burning nacelle, In case of a person who has been injured somehow and therefore needs to stay inside the descent module on the ground until help arrives, it may also be highly advantageous that the inside is shielded from i.a. rain and wind.

In a preferred embodiment, said descent module is configured to protect said one or more persons inside the descent module, e.g. from fire and/or thermal hazards, from impact from e.g. falling objects, debris and the like, and wherein said one or more persons can stay inside the descent module after it has reached the lower level, e.g. until rescue personnel reaches the wind turbine location.

In an embodiment of the invention, said descent module is designed in such a manner that, when it is located at said position at the nacelle of the wind turbine, at least one person can enter the descent module, for example from the top of the nacelle or via a door, hatch or the like in the nacelle.

In an embodiment of the invention, the emergency system is configured as a retro-fit system or as built-in system.

A second aspect of the invention provides a descent module configured to accommodate at least one person while descending down at least a portion of a height of a tower of a wind turbine, the descent module comprising at least one magnet for magnetically attracting the descent module to a tower of a wind turbine to guide the descent module relative to the tower over at least a portion of a descent. The descent module may be a descent module for a wind turbine according to the first aspect of the invention. The descent module may include any of the features described above in relation to the descent module of the wind turbine of the first aspect of the invention.

A third aspect of the invention provides a method of lowering at least one person down at least a portion of a height of a tower of a wind turbine, the method comprising:

accommodating at least one person in a descent module; lowering the descent module down at least a portion of the height of the tower; and magnetically attracting the descent module to the tower to guide the descent module relative to the tower over at least a portion of the descent. The method may be used in operating a wind turbine according to the first aspect of the invention. The method may include any steps associated with the normal operation of such a wind turbine.

It will be appreciated that the above-described features may be included independently or alternatively together in any combination.

### BRIEF DESCRIPTION OF THE DRAWINGS

The invention will now be described in detail with reference to the accompanying drawings, in which:

FIG. 1 schematically illustrates a wind turbine comprising a descent module in accordance with one possible embodiment of the present invention;

FIG. 2 schematically illustrates the top portion of the wind turbine of FIG. 1;

FIG. 3 schematically illustrates the descent module of the wind turbine of FIG. 1;

FIG. 4 schematically illustrates a plan view of the descent module of the wind turbine of FIG. 1;

FIGS. 5a and 5b schematically illustrate a wheel including magnets that may be used in an alternative embodiment of the invention; and

FIG. 6 schematically illustrates the top portion of a wind turbine according to an alternative embodiment of the present invention.

### DETAILED DESCRIPTION

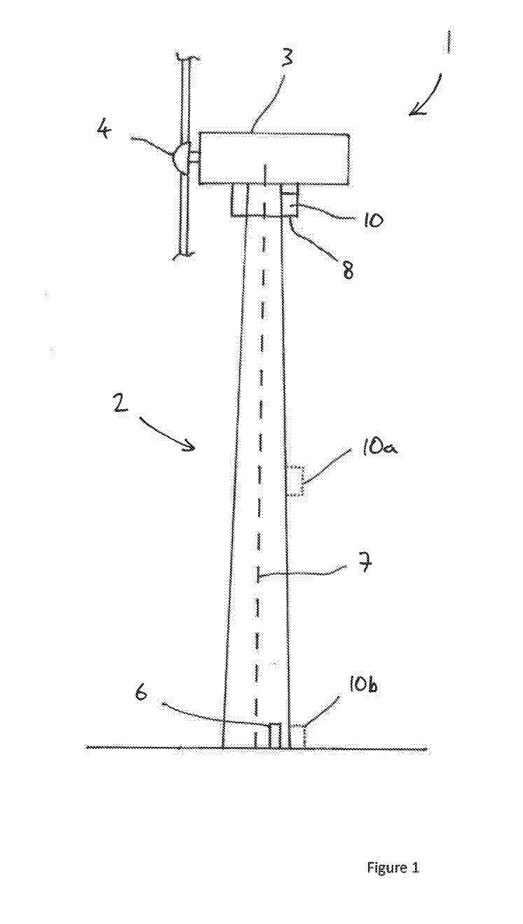

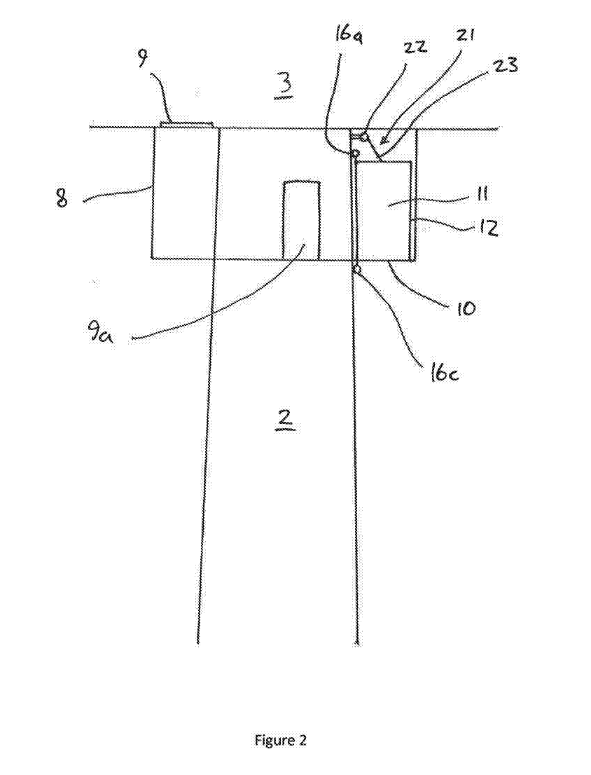

FIG. 1 schematically illustrates a wind turbine 1 according to one possible embodiment of the present invention. FIGS. 2 to 4 schematically illustrate specific portions of the wind turbine, as described in more detail below.

The wind turbine is an on-shore wind turbine (although the invention may equally be applied to an off-shore wind turbine). The wind turbine 1 comprises a tower 2, a nacelle 3 rotatably coupled top the top of the tower, and a rotor 4 including a plurality of blades coupled to the nacelle. The rotor 4 is connected to an electrical generator housed within the nacelle 3 by a drivetrain. The tower has 2 a generally circular cross-section and widens towards its base. The tower 2 is substantially formed of steel panels or sections.

The interior of the tower 2 may be accessed via a lower door 6 in the tower. The tower 2 further comprises an internal lift system 7 which may be accessed via the lower door 6, and which extends into the nacelle 3 to provide direct access to the nacelle. The internal lift system 7 may be used for transporting one or more people (such as engineers or mechanics) to or from the top of the wind turbine 1.

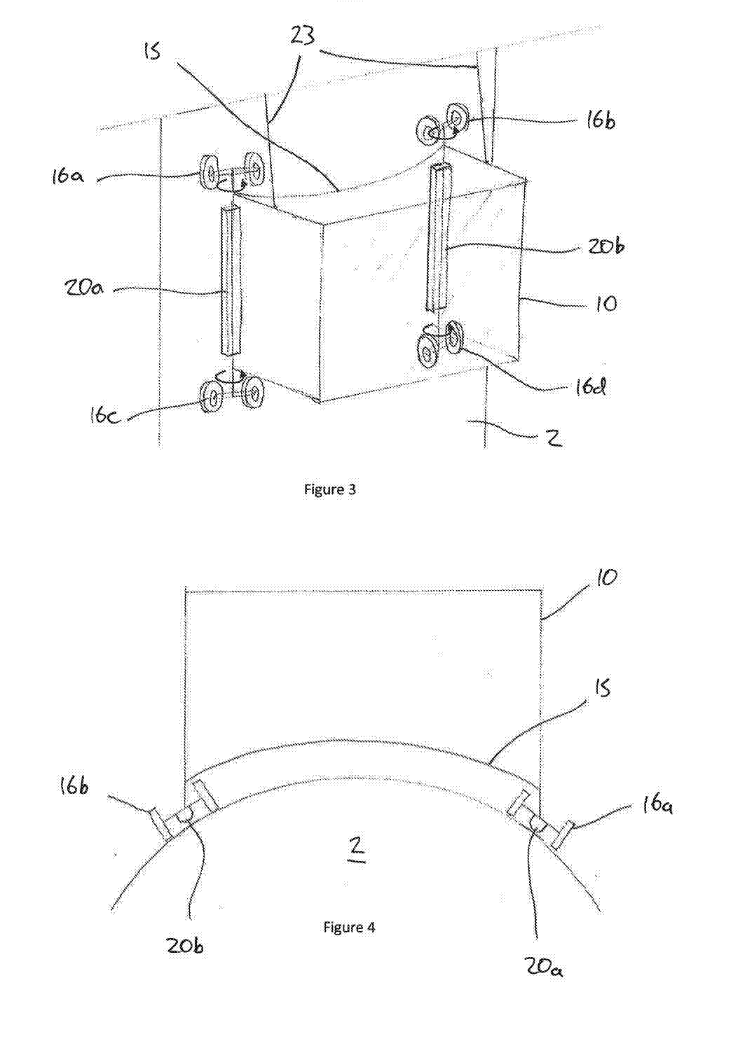

The wind turbine further comprises a descent module 10 for allowing people to descend from the top of the wind turbine 1 to the base of the tower 2 in an emergency. The descent module is most clearly illustrated in FIG. 2 (which shows an enlarged view of the top of the tower 2) and FIGS. 3 and 4 (which show the descent module in perspective view and plan view respectively). The descent module 10 comprises an enclosed cage 12 providing a chamber 11 that is arranged to comfortably receive and carry a plurality of people during a descent from the top of the wind turbine 1 to the base of the tower 2. The chamber 11 may also be arranged to carry at least one person on a stretcher. The chamber 11 may be accessed via a door provided in a sidewall of the cage 12. In other embodiments the chamber may have solid walls and/or may be at least partially open.

The wind turbine 1 further comprises an external access system 8 (most clearly illustrated in FIG. 2) that is located towards the top of the tower 2 and below the nacelle 3.The descent module 10 may be entered from the external access system 8 when the descent module 10 is in its initial position before the start of a descent, as illustrated in FIG. 2. The external access system 8 is located outside the tower 2 and the nacelle 3, and comprises an enclosed cage extending circumferentially around the tower 2 that provides a walkway from which the descent module 10 may be entered. In other embodiments the external access system may have solid walls and/or may be at least partially open, and may not extend around the entire circumference of the tower.

The walkway is accessible from the nacelle 3 through a door 9 provided in a floor of the nacelle 3 that opens to the external access system 8. The schematic illustration of FIG. 2 only shows a single door 9 in the floor off the nacelle 3. However, it is preferable to include a plurality of doors 9 through which the walkway can be accessed in the nacelle 3 so that the walkway can be accessed from several different positions inside the nacelle, and so that the walkway can be accessed directly from the nacelle even if one of the doors is blocked. In addition, the walkway is accessible from inside the top of the tower 2 through at least one further door 9a provided towards the top of the tower that opens to the external access system 8.

The external access system 8 is attached to the tower 2, for example by bolts or welded joints, and remains fixed relative to the tower 2 as the nacelle 3 rotates during operation of the wind turbine 1.

When not in use, the descent module 10 is located within the cage of the external access system 8, as shown in the schematic illustrations of FIGS. 1 and 2, although in other embodiments at least a portion of the descent module 10 may protrude from the external access system 8. In this initial position, the descent module 10 is releasably mounted to the tower 2 and/or the to the external access system 8 by a releasable retaining mechanism. The releasable retaining mechanism may, for example, comprise one or more releasable latches.

The descent module 10 comprises a tower-facing wall 15 provided by the cage 12. As shown in the schematic illustrations of FIGS. 3 and 4, the tower-facing wall 15 has a concave shape that is arranged to fit around the curved shape of the tower 2 during a descent. The descent module 10 further comprises four sets of wheels 16a, 16b, 16c, 16d arranged at the four corners of the tower-facing wall 15 in a substantially square configuration, as shown in the schematic illustration of FIG. 3. Each set of wheels 16a, 16b, 16c, 16d comprises a pair of rubber wheels each having a substantially flat radially outer surface. The wheels 16a, 16b, 16c, 16d are arranged to directly engage and roll along the outer surface of the tower 2 during a descent, as described in more detail below. Each set of wheels 16a, 16b, 16c, 16d is mounted to the cage 12 of the descent module 10 via a mounting component that is arranged to pivot about a substantially vertical axis in use in order to allow the wheels to remain in contact with the tower 2 and follow the shape of the tower over a descent. In the present embodiment the wheels 16a, 16b, 16c, 16d are maintained in contact with the outer surface of the tower even when the descent module is in its initial position prior to use, although in other embodiments the wheels may be brought into contact with the outer surface of the tower only after a decent has been initiated.

The descent module 10 further comprises first and second magnets 20a, 20b arranged respectively at each side of the tower-facing wall 15, as shown in the schematic illustrations of FIGS. 3 and 4. Each of the first and second magnets is fixed relative to the cage 12, and is disposed between and located adjacent to one of the upper sets of wheels 16a, 16b and one of the lower sets of wheels 16c, 16d. The magnets 20a, 20b are arranged to attract the descent module 10 to the steel sheets or segments forming the tower 2 in order to guide the descent module relative to the tower during a descent, as described in more detail below. In order to maximise their effect, the magnets 20a, 20b are arranged to be as close to the outer surface of the tower 2 as is practical without directly engaging the outer surface of the tower during a descent.

The magnets 20a, 20b are permanent magnets, although electromagnets could equally be used. The magnets 20a, 20b may, for example, be alnico magnets or hard ferrite magnets. Each one of the magnets 20a, 20b may take the form of a single magnet, or may comprise a plurality of individual magnet elements.

The wind turbine 1 further comprises a lowering mechanism 21 for lowering (and in some embodiments raising) the descent module 10 from the top of the wind turbine 1 to the base of the tower 2. The lowering mechanism 21 is arranged to control the speed of the descent module 10 during a descent. The lowering mechanism comprises a winch drum 22 that is attached to the tower 2 (or alternatively to the access system 8), and carries at least one cable 23 that is attached to (or at least attachable to) the cage 12 of the descent module 10.

Electronic control elements (or alternatively mechanical control elements) are provided both within the descent module 10 and at another location in the wind turbine 1 outside the descent module in order to control operation of the descent module, for example to initiate a descent.

The descent module 10 and/or the external access system 8 may form part of the wind turbine 1 as originally designed and built, or may alternatively have been retro-fitted to the wind turbine (even if the wind turbine was not originally designed to include a descent module or an external access system for a descent module).

Operation of the descent module 10 will now be described.

When it is desired to lower one or more people from the top of the wind turbine 1 in an emergency situation in which it is impossible or at least undesirable to use the internal lift system 7, the one or more people to be evacuated from the top of the wind turbine may enter the walkway provided in the external access system 8 via the door 9 (or one of the doors) provided in the floor of the nacelle 3. From there, the one or more people may enter the chamber 11 of the descent module 10 through the door provided in the cage 12 of the descent module 10. Once the one or more people are located inside the chamber 11 of the descent module 10, one of the control elements may be operated (either from inside the descent module by one of the people in the descent module or from outside the descent module by an operator outside the descent module) to release the descent module 10 from the tower and/or the external access system and initiate the descent.

Once the descent has been initiated, the descent module 10 begins to descend from the top of the wind turbine 1 under the action of gravity. During the descent, the wheels 16a, 16b, 16c, 16d roll along the outer surface of the tower 2, and the magnets 20a, 20b comprised in the descent module 10 act to attract the descent module to the steel panels or sections forming the tower 2. In this way, the descent module 10 is guided relative to the tower 2, with the magnets 20a, 20b helping to ensure the descent module is safely and reliably controlled during its descent. The guiding effect of the magnets 20a, 20b is maximised by arranging the magnets to be as close as is practical to the outer surface of the tower 2 during the descent, as described above. The descent module is shown at an intermediate point of its descent at 10a in the schematic illustration of FIG. 1.

The speed of the descent is controlled by the lowering mechanism 21.

By attracting the magnets 20a, 20b of the descent module 10 to structural components of the tower 2, the guiding functionality provided by the magnets may be achieved without the addition of any further magnetic components in the tower specifically for the purpose of attracting the descent module. Similarly, by arranging the wheels 16a, 16b, 16c, 16d to roll along the outer surface of the main body of the tower 2 it is possible to control the movement of the descent module 10 without the addition of any further mechanical components in the tower specifically for the purpose of engaging the descent module.

As the descent module is lowered down the tower on the cables 23, each set of wheels 16a, 16b, 16c, 16d is allowed to pivot about its pivot axis in order to allow the wheels to remain in normal contact with the outer surface of the tower 2 and follow the widening shape of the tower over the descent.

When the descent module 10 reaches the base of the tower 2 at the end of its descent, as indicated at 10b in the schematic illustration of FIG. 1, the door of the descent module may then be opened to allow the one or more people to exit the descent module.

In this way the one or more people may be evacuated from the top of the wind turbine 1 to the base of the wind turbine.

After use of the descent module 10, it needs to be returned to the top of the tower if the wind turbine is to be used again. In some embodiments, the lowering mechanism 21 may be operated in reverse to return the descent module to its initial position. Alternatively, the lowering mechanism is intended only to lower the descent module, and an external winch or the like should be used for this purpose. This provides a saving on the strength and design of the lowering mechanism, which is most likely worth it considering the limited number of times the descent module is expected to be in use. The magnets 20a, 20b also act to guide the descent module 10 over the upper part of its ascent. Once the descent module 10 has returned to its initial position near to the top of the tower 2, the retaining mechanism may then be reengaged in order to retain the descent module in its initial position ready for further use.

In the above-described embodiment, the tower 2 is formed of steel panels or sections over substantially its entire height, and so the descent module is attracted to the tower over substantially the entire descent without any requirement for further magnetic components specifically for the purpose of attracting the descent module. However, in other embodiments, at least a portion of the tower 2 may be formed of a non-magnetic material. For example, in another embodiment, the tower 2 may comprise a lower portion that is formed of concrete panels or sections and an upper portion that is formed of steel panels or sections. In this case the descent module may be attracted to the tower only over an upper portion of its descent (corresponding to the magnetic portion of the tower), and the action of gravity and the outer surface of the tower may be sufficient to guide the descent module over a lower portion of its descent. Alternatively, one or more additional magnetic components may be provided in or on the non-magnetic portion of the tower specifically for the purpose of attracting the descent module. In this case the descent module may still be attracted to the tower over portions of its height that are generally formed of non-magnetic materials.

In the above-described embodiment, two magnets are provided in the descent module, with each magnet extending between an upper set of wheels and a lower set of wheels. However, in other embodiments the number of magnets and the location of the magnets may be different. For example, one or more magnets may be provided at a central location on the tower-facing wall of the descent module in between the sets of wheels, or four individual magnets may be provided adjacent to (either to the side of or behind) each set of wheels.

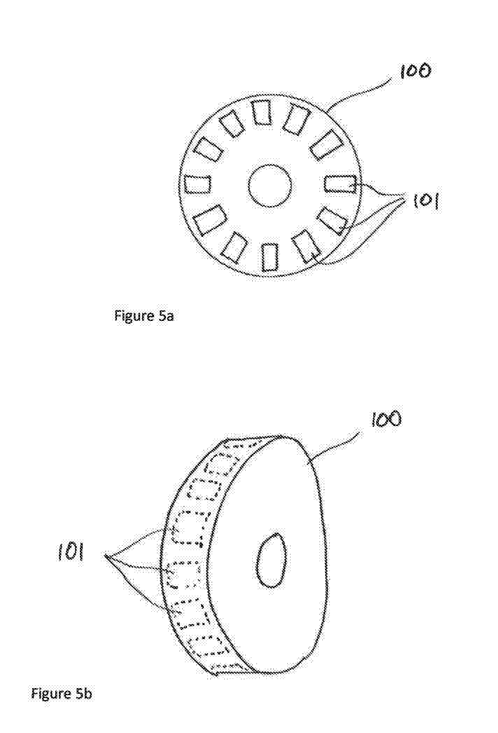

Alternatively or in addition to any of the magnet arrangement described above, it is also possible for one or more magnets to be provided in one or more of the wheels (or alternatively other tower engaging elements) of the descent module. For example, FIGS. 5a and 5b schematically illustrate a wheel 100 that may be used in a descent module as described above. The wheel comprises a plurality of magnets 101 arranged around its circumference and embedded within a main body, which may be formed of rubber. When wheels 100 of this type are fitted to the descent module, the wheels themselves magnetically attract the magnetic components of the tower during a descent to thereby attract the descent module to the tower.

As an alternative to including one or more magnets in the descent module, it is also possible to provide at least one magnet, and preferably a track of magnets, in the tower, the magnets acting to attract one or more magnetic components of the descent module (for example steel components of the descent module) to thereby guide the descent module during a descent.

In the above-described embodiment, the external access system is attached to the tower. However, in other embodiments the external access system could alternatively be attached to the nacelle. In addition, the descent module could alternatively be located below or to the side of (instead of within) the external access system when in its initial position.

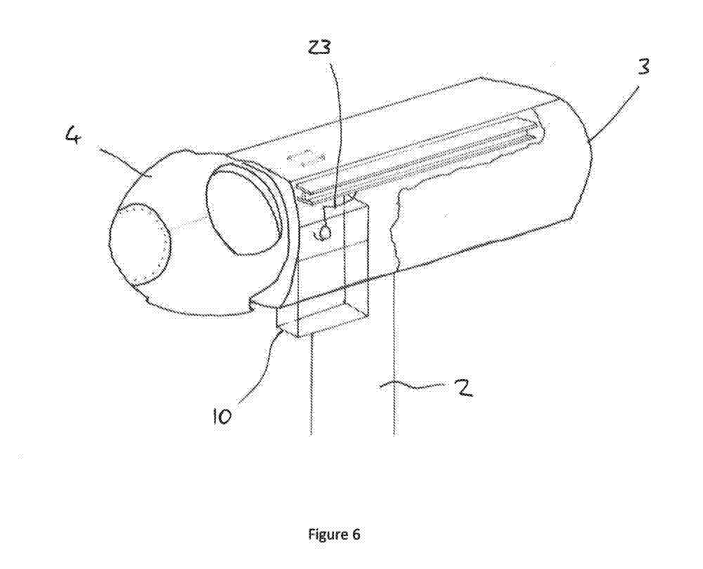

In the above-described embodiment, the descent module is arranged to be entered from an external access system. However, the external access system is not required in all embodiments, and the descent module may alternatively be arranged to be entered directly from the nacelle, or directly from the tower. For example, FIG. 6 schematically illustrates an alternative embodiment in which the descent module 10 is located at least partially within the nacelle 3 when in its initial position. In this alternative embodiment the descent module may be lowered down the wind turbine on a cable 23 that is attached to a structural part of the nacelle 3 (such as the skeleton beam).

In the above-described embodiment, the descent module is provided in addition to an internal lift system within the tower, and is intended for use only in emergency situations. However, in other embodiments the descent module may instead provide the primary (and possible only) system for ascending the wind turbine and/or descending from the wind turbine.

It will be appreciated that many other modifications and variations are also possible within the scope of the appended claims.

1. A wind turbine comprising a tower, a nacelle, and a descent module configured to accommodate at least one person while descending down at least a portion of a height of the tower, wherein the descent module is arranged to be magnetically attracted to the tower to guide the descent module relative to the tower over at least a portion of the descent.

2. The wind turbine according to claim 1, wherein the descent module comprises a plurality of tower engaging elements arranged to engage at least a portion of the tower over at least a portion of the descent.

3. The wind turbine according to claim 2, wherein the tower engaging elements are arranged to pivot in use in order to follow the shape of the tower over the descent.

4. The wind turbine according to claim 2, wherein the tower engaging elements are wheels that are arranged to engage and roll along at least a portion of the tower over at least a portion of the descent.

5. The wind turbine according to claim 1 4, wherein the descent module comprises at least one magnet arranged to attract at least one magnetic component of the tower to thereby guide the descent module relative to the tower over at least a portion of the descent.

6. The wind turbine according to claim 5 wherein the magnet(s) are provided at one or more intermediate locations between the plurality of tower engaging elements of the descent module, and/or wherein the magnet(s) are provided at one or more locations adjacent to one or more of the tower engaging elements of the descent module.

7. The wind turbine according to claim 5, wherein the magnet(s) are comprised in one or more of the tower engaging elements of the descent module.

8. The wind turbine according to claim 1 wherein the wind turbine further comprises an external access system located towards a top of the tower, and at least partially outside the nacelle and the tower, from which at least one person may enter the descent module.

9. The wind turbine according to claim 8, wherein the descent module is located at least partially within the external access system when in its initial position before the start of a descent.

10. The wind turbine according to claim 8, wherein the descent module is releasably mounted to the external access system and/or to the tower when in its initial position before the start of a descent.

11. The wind turbine according to claim 1 wherein the descent module is arranged to be accessed directly from the nacelle or directly from the tower.

12. The wind turbine according to claim 1, wherein the wind turbine further comprises a lowering mechanism for controlling the speed of descent of the descent module.

13. The wind turbine according to claim 12, wherein the lowering mechanism is mounted to the tower or to the nacelle and comprises a cable that is attached to or arranged to be attached to the descent module.

14. The wind turbine according to claim 12, wherein the lowering mechanism is additionally operable to lift the descent module up the tower.

15. The wind turbine according to claim 1, wherein said descent module is designed for accommodating a plurality of people, such as at least two, at least three or at least four people.

16. The wind turbine according to claim 1, wherein said descent module is designed for accommodating at least one person on a stretcher.

17. The wind turbine according to claim 1, wherein said descent module comprises manual input means, e.g. a handle, a knob or the like, which is designed for activating releasing means for providing a release from said position at said upper level.

18. The wind turbine according to claim 1, wherein said descent module is an essentially closed structure having an entrance, e.g. a door, a hatch or the like, for at least one person.

19. The wind turbine according to claim 1, wherein said descent module is configured to protect said one or more persons inside the descent module, e.g. from fire and/or thermal hazards, from impact from e.g. falling objects, debris and the like.

20. The wind turbine according to claim 1, wherein said descent module is designed in such a manner that, when it is located at said position at the nacelle of the wind turbine, at least one person can enter the descent module, for example from the top of the nacelle or via a door, hatch or the like in the nacelle.

21. The wind turbine according to claim 1, wherein the emergency system is configured as a retro-fit system or as built-in system.

22. A descent module configured to accommodate at least one person while descending down at least a portion of a height of a tower of a wind turbine, the descent module comprising at least one magnet for magnetically attracting the descent module to a tower of a wind turbine to guide the descent module relative to the tower over at least a portion of a descent.

23. The descent module according to claim 22, wherein said descent module is an essentially closed structure having an entrance, e.g. a door, a hatch or the like, for at least one person.

24. A method of lowering at least one person down at least a portion of a height of a tower of a wind turbine, the method comprising:
accommodating at least one person in a descent module;
lowering the descent module down at least a portion of the height of the tower; and
magnetically attracting the descent module to the tower to guide the descent module relative to the tower over at least a portion of the descent.

25. A method of performing an emergency exit from an upper level of a wind turbine according to claim 1, whereby
at least one person located at an upper level, e.g. in or on the nacelle, in or at the upper level of the wind turbine tower, or the like, enters the descent module,
said at least one person activates releasing means of the descent module, whereby the descent module is released from its position at the nacelle and descends down at least a portion of a height of the tower, wherein the descent module is arranged to be magnetically attracted to the tower to guide the descent module relative to the tower over at least a portion of the descent.

26. The method according to claim 25, wherein said descent module is configured to protect said one or more persons inside the descent module, e.g. from fire and/or thermal hazards, from impact from e.g. falling objects, debris and the like, and wherein said one or more persons can stay inside the descent module after it has reached the lower level, e.g. until rescue personnel reaches the wind turbine location.
